(19) United States
(12) Patent Application Publication
(10) Pub. No.: US 2007/0065541 A1
(43) Pub. Date: Mar. 22, 2007

(54) Enhanced infant formula containing liposome encapsulated nutrients and agents

(75) Inventors: Brian C. Keller, Antioch, CA (US); Arnold William Schwartz, Ross, CA (US)

Correspondence Address: MORRISON & FOERSTER LLP, 12531 HIGH BLUFF DRIVE, SUITE 100, SAN DIEGO, CA, 92130-2040, US

(73) Assignee: Biozone Laboratories, Inc., Pittsburg, CA (US)

(21) Appl. No.: 11/519,257

(22) Filed: Sep. 11, 2006

Related U.S. Application Data
(63) Continuation of application No. 09/530,795, filed on Jun. 25, 2000, now abandoned.
(60) Provisional application No. 60/064,518, filed on Nov. 5, 1997.

(51) Int. Cl. A23L 1/30

(52) U.S. Cl. 426/72

(57) ABSTRACT

An infant formula contains liposomes which improve the nutritional delivery of nutrients, stabilize ingredients, and enhance their bioavailabilty. The formula more closely resembles the ultrastructure and infrastructure of natural human milk due to the presence of liposomes. The lipid concentration is in the range of 0.1-50% of the formulation. The typical size of the liposomes range between about 20 nm and about 500 nm. The formula can be formulated to be in a liquid or dry form. The phospholipid concentration is the same as that which occurs in human milk.

### CROSS-REFERENCE TO RELATED APPLICATIONS

This application is a continuation of U.S. application Ser. No. 09/530,795, filed Jun. 25, 2000, which is a national phase of PCT Application No. PCT/US98/23532, internationally filed Nov. 5, 1998, which claims the benefit of provisional U.S. Application Serial No. 60/064,518, filed Nov. 5, 1997. The contents of these documents are incorporated herein by this reference.

### TECHNICAL FIELD

This invention relates generally to the formulation of infant milk formula and more specifically to the composition and ultrastructure of infant formula to be more like mother's milk.

### BACKGROUND ART

Breast-feeding is, without question, the preferred method of feeding infants in the first months of life. The benefits of human milk both nutritional and nonnutritional have been thoroughly discussed (Fomon, S. J., Infant Nutrition, W B Saunders, Philadelphia, 1978, and Oski, F. A., in “Pediatric Nutrition,” ed. F. Lifshitz, Marcel Dekker, New York, Ch. 3, pp. 55-62, 1980) in support of the belief that it is the optimal source of nutrition for the developing infant. Human milk provides essential quantities of energy, protein, carbohydrates, minerals and vitamins to achieve growth of the healthy infant. The nonnutritional benefits contribute to the well being of both mother and child. They include: developing the mother-child bond, breast fed infants have less childhood bacterial and viral infections; they have a reduced incidence of severe or obvious atopic disease, and are less susceptible to hypothyroidism. Maternal benefits include reduction of the incidence of breast cancer, and early repeat pregnancy.

Human milk has been well studied and reviewed over the last century (Pipes, P., Nutrition in Infancy and Childhood, 4th ed., St. Louis, Times Mirror/Mosby College Publishing, 1989, and Williams, A. F., Textbook of Pediatric Nutrition 3rd ed. London: Churchill Livingston, 1991). Analysis of the composition of human milk reveals that it is an elaborate solution that contains more than 200 fat-soluble and water-soluble ingredients.

The concentration of nutrients in human milk has been used as the gold standard by which all forms and sources of infant nutrition are judged. Breast milk from a well nourished woman, if taken in adequate quantities by the infant, provides adequate daily requirements of minerals, vitamin A, thiamine, riboflavin, niacin, pyridoxine, vitamin B₁₂, folic acid, ascorbic acid, and vitamin E. The amounts of vitamin D, vitamin K and iron are often low and may require supplementation.

Lactose is the sole carbohydrate source in human milk. It is enzymatically broken down by lactase into galactose and glucose and absorbed through the small intestine. Milk proteins are defined broadly as either whey or casein. Casein is a mixture of phosphoproteins, rich in essential and common amino acids. Whey from human milk consists of alpha-lactoalbumin, lactoferrin, albumin, and immunoglobulins IgA, IgG, and IgM. The fat components of human milk contribute 3-4.5% of fat per 100 ml. The major fatty acids in human milk are stearic, oleic, plamitic and linoleic acids which provide the building blocks that form triacylglycerols (triglycerides) which make up 98-99% of the total fat in milk. In addition, phospholipids and cholesterol contribute 1-2% of total fat. (Hamosh, M., et al., Pediatrics (1985) 75(suppl):146-50.

The components and individual ingredients of human milk help make this nutritional substance the ideal food for infants. In addition, however, the ultrastructure of human milk is an essential factor in its biological performance. Some primary papers and review articles (Jensen, R. G., Progress in Lipid Res (1996) 35(1):53-92) deal with the microscopic ultrastructure of milk. The ultrastructure bodies that have been identified include: micelles, submicelles, fat globules, and milk fat globule membrane (MFGM, the proteinaceous coat surrounding fat globules). The complex milk protein system that makes up casein is known to form micelles and submicelles. Kappa-casein is the protein fraction of milk that allows formation of micelles and determines micelle size and function, thus affecting many of the physical characteristics of milk.

The milk fat globule is another complex body made up of triglycerides and the structure-function relationship is one of the factors controlling digestion. The histochemistry and microscopic structure of human milk fat globule membrane is thoroughly treated by Buchheim, W., et al., “Electron microscopy and carbohydrate histochemistry of human milk fat globule me.,” in: Hansen, L. A., ed. Biology of human milk, Nestle Nutrition Workshop Series, Vol. 15, Raven Press, New York, 1988.

In many areas of the world, and in many situations, breast-feeding is not possible due to factors including mother-infant separation, infant inability or disease state, and mother inability or disease state. The nutrition of choice in these cases is infant formula. Commercially available infant formulas have been marketed since the early 1900s and have reached their current state of quality and evolution over the past 65 years. Advances in nutrition, biology and medicine during this time period have allowed infant formulas to achieve high nutritional quality, safety, and uniformity.

The aim of infant formulation is to make the very best substitute possible and to make the preparation more like mother's milk. Many existing formulas combine the same ingredients, have the same amount of calories, match renal solute load and achieve the exact osmolarity and osmolality as the standard, mother's milk. However, the complex ultrastructure of human milk has not been duplicated in infant formulas due to expense, technological know-how, and complete knowledge of ultrastructure.

This suggests that there is a need for new formulations that are chemically, calorically, compositionally, and nutritionally the same as human milk as well as structurally the same as human milk to meet the needs of developing infants worldwide.

Liposomes are microscopic lipid vesicles comprised of a lipid bilayer membrane that surrounds and separates a water compartment. A liposome can have a single bilayer membrane called a small unilamellar vesicle (SUV) or many layers which is called a multilamellar lipid vesicle (MLV). The membrane of liposomes is made from bilayer forming lipids, for example, phospholipids, sphingolipids, and cholesterol. Liposomes were first described by Banhem et al., J Mol Biol (1965) 13:238-252. Liposome technology has evolved over the past 30 years to become a preeminent drug and nutritional delivery science. Liposomes have been used in applications ranging from decreasing the cardiotoxicity of cancer drugs to topical penetration enhancement to gene delivery since their discovery.

Liposomes can encapsulate a variety of biologically active ingredients. The interaction of different molecules with liposomes such as water-soluble molecules are entrapped, or bound, either hydrophobically, electrostatically, or electrodynamically, to the liposome surface. Amphiphilic molecules orient into bilayers, and hydrophobic substances are dissolved in the bilayer. Complex macromolecules and proteins can also find different ways to accommodate and anchor into or bind or adsorb onto the bilayer. In particular cases some hydrophobic molecules can be entrapped or loaded into the liposome interior at so high concentrations that they precipitate or gel inside. Lasic, D. D., Liposomes: From Physics to Applications, Elsevier, New York, pp. 6-7, 1993.

Keller et al. have recently discovered the presence of liposomes in human milk. Electronmicrographs show the presence of SUVs and MLVs in the size range of 50-100 nm. these liposomes are thought to be comprised of the phospholipids, sphingomylens, and cholesterol, which exist in human milk. Because liposomes have also been shown to enhance the oral bioavailability of ingested ingredients (Maitani, Y. et al., J Pharm Sci (1996) 85(4):440-445 and Sakuragawa, N. et al., Thrombosis Res (1985) 38(6):681-685) that are poorly absorbed or not absorbed at all with liposome encapsulation, the use of liposomes orally has important applications such as in orally ingested products such as infant formulas. Since formula cannot match mother's milk in general availability of nutrients, the presence of liposomes may help explain this fact. This important ultrasctructure discovery further characterizes human milk and makes possible formulating infant formula to be even closer to mother's own, and to enhance bioavailability of nutrients in a variety of orally consumed products.

### DISCLOSURE OF THE INVENTION

The present invention broadly relates to the use of liposomes in nutritional supplement products, drug products, and infant formula products for oral use in mammals and to improve the nutritional delivery of nutrients, stabilize ingredients, and enhance the bioavailabilty of ingredients in these products using liposomes.

The materials used to form liposomes in this invention include any natural, bilayer forming lipids including those lipids from the classes of glycerolphospholipids, glyceroglycolipids, sphingophospholipids, and sphinogoglycolipids. The concentration of lipid used to form liposomes in this invention can range from 0.1-50% of the formulation. The resulting liposomes have a typical size range of 20 nm-500 nm. Cholesterol, or another sterol such as stigmasterol, can be added to the formulation to enhance the stability of the liposome membrane in concentrations of 0.05-30%.

Micronutrients, proteins, immunoglobulins, vitamins and mineral were encapsulated into liposomes using a modification of the reverse phase evaporation technique. (Lasic, D D. Liposomes. From physics to applications. Elsevier Press, New York. 1993; 92-94.) in order to: 1) prevent oxidation of ingredients, 2) stabilize the colloidal formulation, 3) enhance the oral bioavailability of encapsulated and associated nutrients, 4) sequester ingredients from one another to prevent interactions, and 5) increase stability of the encapsulated ingredients.

Enhancement of oral bioavailibility due to liposomes in the formulation, and in mothers milk, is predicated on the fact that polar lipids assist nutrient and fat absorption. Normally, when infant formula or mothers milk reaches the upper duodenum, where bile salts are secreted, micelles form to help assist in the dispersion and emulsification of fats and triglycerides. In the present invention, liposomes add another component to the mixture by contributing mixed vesicles. Polar lipids and bile salts form mixed micelles and mixed vesicles which increase absorption of fats and oil soluble ingredients in milk in the interstine.

Liquid infant formulations are emulsions of edible oils in an aqueous solution. Frequently infant formulas contain stabilizers, such as carrageenan. When bilayer forming lipids assemble into liposomes then also act as emulsufiers and stabilize the solution so carrageenan or other emulsifiers and stabilizers are not needed.

Another aspect of this invention is that the nutrients, vitamins, immunoglobulins and proteins can be encapsulated into liposomes and this complex can be dehydrated by known drying techniques and then combined with dry whey powder and other ingredients to make powder infant formula. When this powder formula is added to water and stirred the liposomes will reform, the resultant solution is a liposomal dispersion.

### MODES OF CARRYING OUT THE INVENTION

The following examples are intended to illustrate but not to limit the invention.

### EXAMPLE 1

Formula 1

| Ingredient | Conc./L | % w/w |
|---|---|---|
| Purified Water | | 98.32% |
| Purified Lecithin (Phospholipon 90) | | 1.0% |
| Cis 4,7,10,13,16,19 Docosahexaenoic Acid (Sigma) | 500 mg | 0.05% |
| Arachidonic Acid (Fluka) | 300 mg | 0.03% |
| Vitamin E (Tocopheryl Acetate) | | 0.1% |
| Cholesterol (Sigma) | | 0.5% |

Formula 2

| Ingredient | Conc./L | % w/w |
|---|---|---|
| Purified Water | | 98.39% |
| Zinc (from Zinc Acetate) | 10 mg | 0.001% |
| Iron (from Ferrous Sulfate) | 16 mg | 0.0016% |
| Copper (from Cupric Sulfate) | 0.8 mg | 0.00008% |
| Selenium (from Sodium Selenate) | 0.2 mg | 0.00002% |
| Purified Lecithin (Phospholipon 90) | | 1.0% |
| Vitamin E (from Tocopheryl Acetate) | | 0.1% |
| Cholesterol (Sigma) | | 0.5% |

Formula 3

| | Conc./ | | |
|---|---|---|---|
| Ingredient | 100 ml | | % w/w |
| Non-fat cow's milk | | | 34.0% |
| Purified Water | | | 21.0% |
| Formula 1 | | | 10.0% |
| Formula 2 | | | 10.0% |
| Lactose | 4.55 | g | 4.55% |
| Palm Olein | | | 7.0% |
| Soy Oil | | | 6.0% |
| Sunflower Oil | | | 7.0% |
| Vitamin A | 200 | IU | 0.00011% |
| Vitamin D | 40 | IU | 1 × 10⁻⁹% |
| Vitamin E | 1.5 | IU | 0.0015% |
| Vitamin K | 6.0 | mcg | 6 × 10⁻⁶% |
| Thiamine | 40.0 | mcg | 0.00004% |
| Riboflavin | 100.0 | mcg | 0.0001% |
| Vitamin B6 | 50.0 | mcg | 0.00005% |
| Vitamin B12 | 0.22 | mcg | 2.2 × 10⁻⁷% |
| Niacin | 500.0 | mcg | 0.0005% |
| Folic Acid | 6.0 | mcg | 6 × 10⁻⁶% |
| Pantothenic Acid | 300.0 | mcg | 0.0003% |
| Ascorbic Acid | 6.0 | mg | 0.006% |
| Biotin | 1.2 | mcg | 1.2 × 10⁻⁶% |
| Choline | 12.0 | mg | 0.012% |
| Inositol | 15.0 | mg | 0.015% |
| Calcium | 50.0 | mg | 0.05% |
| Phosphorus | 36.0 | mg | 0.035% |
| Magnesium | 5.0 | mg | 0.005% |
| Manganese | 5.0 | mg | 0.005% |
| Iodine | 6.0 | mg | 0.006% |
| Sodium | 10.0 | mg | 0.01% |
| Potassium | 60.0 | mg | 0.06% |
| Chloride | 20.0 | mg | 0.02% |

In this example, a milk-based infant formula (Formula 1, 2 or 3) is prepared with the same concentration of phospholipid that occurs in human milk. Using purified phospholipids from soy (Phospholipon 90H, Natterman Phospholipid, Cologne, Germany), liposomes were formulated which entrapped zinc, iron, copper, and selenium, into one liposome system and docosahexenoic acid (DHA), arachidonic acid were entrapped into another liposome system. The purpose of this formulation was to sequester the respective encapsulates and prevent interaction in the final formulation where the minerals can cause the oxidation of the lipids.

### EXAMPLE 2

Formula 1

| Ingredient | % w/w |
|---|---|
| Purified Water | 51.8% |
| L-Carnitine HCL (Sigma) | 20.0 |
| Purified Lecithin (Phospholipon 90H) | 2.0% |
| Cholesterol (Sigma) | 1.0% |
| Tocopheryl Acetate | 0.2% |
| Palm Olein | 10.0% |
| Fructose | 10.0% |
| Lactose | 5.0% |

In this example, L-carnitine was encapsulated into a liposome using purified phospholipids from soy (Phospholipon 90H) and add liposome/L-carnitine to a milk-based infant formula. L-carnitine has poor oral bioavailability. The purpose of this formulation was to enhance the oral bioavailability of L-carnitine.

### EXAMPLE 3

Formula 1

| Ingredient | Conc./L | % w/w |
|---|---|---|
| Purified Water | | 81.999% |
| IgG Human (Fluka) | 10.0 mg | 0.001% |
| Purified Lecithin (Phospholipon 90H) | | 2.0% |
| Cholesterol (Sigma) | | 1.0% |
| Fructose | | 10.0% |
| Lactose | | 5.0% |

In this example, three immunoglobulins, IgG, IgA, and IgE, were encapsulated. The purpose of this formulation was to stabilize these immunoglobulins in the infant milk-based product. In addition, by encapsulating them into a liposome that is made to withstand the hostile environment of the stomach they are delivered to the small intestine where they increase immunity of the infant.

### EXAMPLE 4

Formula 1

| | Conc./ | | |
|---|---|---|---|
| Ingredient | L | | % w/w |
| Purified Water | | | 91.125% |
| L-Arginine HCl | 4.0 | g | 0.4% |
| L-Cystine HCl | 2.3 | g | 0.23% |
| Taurine | 450.0 | mg | 0.045% |
| Tocopheryl Acetate | | | 0.2% |
| Purified Lecithin (Phospholipon | | | 2.0% |
| 80H) | | | |
| Cholesterol (Sigma) | | | 1.0% |
| Lactose | | | 5.0% |

In this example, arginine, taruine, and cystine were encapsulated into liposomes to enhance survival in the stomach and to enhance the oral bioavailability or these three amino acids.

### EXAMPLE 5

| Ingredient | % w/w |
|---|---|
| Purified Water | 77.176 |
| Ascorbic Acid | 0.3 |
| Citric Acid | 0.3 |
| Dipotassium Hydrogen Phosphate (Mollinckrodt) | 0.2 |
| Sodium Sulfate (Spectrum) | 0.2 |
| Thiamine HCL, USP (Spectrum) | 0.024 |
| Ferrous Sulfate (Spectrum) | 1.8 |
| Hygrogenated Lecithin | 20.0 |

In this example, thiamine HCl and ferrous sulfate were encapsulated into liposomes to enhance survival in the stomach and to enhance the oral bioavailability.

1. In an infant milk formulation wherein the improvement comprises liposomes in amounts to enhance nutritional delivery of nutrients, stabilize ingredients, and enhance the bioavailabilty of ingredients.

2. The infant formulation of claim 1 wherein liposomes include natural, bilayer forming lipids selected from glycerolphospholipids, glyceroglycolipids, sphingophospholipids, sphinogoglycolipids or mixtures thereof.

3. The infant formulation of claim 1 wherein the lipid concentration are in the range of 0.1-50% of the formulation.

4. The infant formulation of claim 1 wherein the liposomes have a typical size range between about 20 nm and about 500 nm.

5. The infant formulation of claim 1 wherein the liposome additionally include in concentrations of 0.05-30% cholesterol, stigmasterol or mixtures thereof to enhance the stability of the liposome membrane.

6. The infant formulation of claim 1 is an emulsions of edible oils in an aqueous solution.

7. The infant formulation of claim 1 additionally contains stabilizers, such as carrageenan.

8. The infant formulation of claim 6 wherein bilayer forming lipids assemble into liposomes which act as emulsufiers and stabilize the solution in the absence of carrageenan or other emulsifiers.

9. The infant formulation of claim 1 additionally includes nutrients, vitamins, immunoglobulins and proteins.

10. The infant formulation of claim 1 has the same concentration of phospholipid that occurs in human milk

11. The infant formulation of claim 1 has purified phospholipids from soy (Phospholipon 90H, Natterman Phospholipid, Cologne, Germany) the liposomes entrap thereby sequestering the respective encapsulates and preventing oxidation of the lipids.

12. The infant formulation of claim 1 wherein the nutrients are thiamine HCl and ferrous sulfate.

13. A process for preparing infant formula comprising,
a) encapsulating nutrients, vitamins, immunoglobulins, proteins or mixtures thereof into liposomes,
b) dehydrating the liposomes,
c) combining the dehydrated liposomes with dry whey powder and other ingredients to make powder infant formula.

14. A process for preparing infant formula of claim 13 further comprising, adding the powdered formula to water and stirring under conditions wherein the liposomes reform forming a liposomal dispersion.
